(19) United States
(12) Patent Application Publication
(10) Pub. No.: US 2024/0082945 A1
(43) Pub. Date: Mar. 14, 2024

(54) BATTERY PACK MANUFACTURING METHOD AND BATTERY PACK

(71) Applicant: AESC Japan Ltd., Zama-shi (JP)

(72) Inventor: Yoshiki KOBAYASHI, Zama-shi (JP)

(73) Assignee: AESC Japan Ltd., Zama-shi (JP)

(21) Appl. No.: 18/508,037

(22) Filed: Nov. 13, 2023

Related U.S. Application Data
(62) Division of application No. 16/480,480, filed on Jul. 24, 2019.

(30) Foreign Application Priority Data
Mar. 10, 2017 (JP) 2017-046160

(51) Int. Cl. B23K 20/10; H01M 50/211; H01M 50/51; H01M 50/514; H01M 50/55; H01M 50/553

(52) U.S. Cl. CPC B23K 20/10; H01M 50/211; H01M 50/51; H01M 50/514; H01M 50/55; H01M 50/553; B23K 2101/36

(57) ABSTRACT

A method of manufacturing a battery pack that is provided with a plurality of stacked unit cells, the method comprising a step of, when a unit cell disposed on one outermost layer is referred to as a first unit cell, and, of the plurality of unit cells stacked in order from the first unit cell, the unit cell disposed on the other outermost layer opposite to that of the first unit cell is referred to as the N^{th}, where N is a positive number of 2 or more, unit cell: arranging an anvil at an external terminal of the Nth unit cell outside the battery pack; arranging a horizontal-vibration horn either at an external terminal of the (N−1)^{th} unit cell outside the battery pack, or between an external terminal of the (N−1)^{th} unit cell and an external terminal of the (N−2)^{th} unit cell; and then using the anvil and the horn to ultrasonically join the external terminal of the N^{th} unit cell and the external terminal of the (N−1)^{th} unit cell.

### CROSS REFERENCE TO RELATED APPLICATIONS

This application is a Divisional of U.S. application Ser. No. 16/480,480, filed Jul. 24, 2019, which is a National Stage of International Application No. PCT/JP2018/002942, filed Jan. 30, 2018, claiming priority to Japanese Patent Application No. 2017-046160, filed Mar. 10, 2017, the contents of all of which are incorporated herein by reference in their entirety.

### TECHNICAL FIELD

The present invention relates to a battery pack that is provided with a plurality of unit cells that are stacked and to a manufacturing method of the battery pack.

### BACKGROUND ART

With the proliferation of various portable devices such as mobile telephones and notebook and tablet personal computers in recent years, demand has grown for lighter and thinner secondary batteries for use in the power supplies of portable devices. As a result, film-sheathed batteries have been increasing in number among secondary batteries, these film-sheathed batteries using as an outer cover, instead of a metal container of the prior art, a metal film or a laminated film in which metal thin-film and heat-sealable resin film are stacked. A film-sheathed battery is of a configuration in which sheet-formed positive electrodes and negative electrodes are laminated or wound with separators interposed therebetween and then enclosed inside an outer covering or sheathing film together with an electrolyte. External terminals (positive electrode terminal and negative electrode terminal) that are connected to the positive electrodes and negative electrodes, respectively, are then led out from the sheathing film via electrode lead-out tabs.

However, secondary batteries in recent years are used not only in the each of the above-described various types of portable devices but also as the power supplies in power-assisted bicycles, electric vehicles, and hybrid automobiles. Still further, in relation to the problem of global warming, secondary batteries are also being used for storing electric power that is generated in renewable power sources such as solar cells that are now being introduced for the realization of a low-carbon society.

When secondary batteries are used for power storage or as the large-scale power supply of an apparatus such as an electric vehicle, there is one form in which a battery pack is configured by stacking a plurality of plate-shaped film-sheathed batteries in the direction of thickness of the batteries and then connecting these batteries in series. In a battery pack of this configuration, each film-sheathed battery must be stacked such that the positions of each positive electrode terminal and negative electrode terminal alternately switch and the external terminals (positive electrode terminals and negative electrode terminals) of adjacent film-sheathed batteries in the direction of stacking are bonded together. As an example, a known ultrasonic joining machine is used in bonding together the external terminals (positive electrode terminals and negative electrode terminals). In this case, the problem arises that the working space needed for joining becomes confined due to the location of the positive electrode terminals or negative electrode terminals of other stacked film-sheathed batteries above or below the positive electrode terminals and negative electrode terminals that are the objects of joining.

In response to this problem, Patent Document 1 discloses a configuration in which the external terminals (positive electrode terminals and negative electrode terminals) of adjacent film-sheathed batteries in the direction of lamination are connected together by a bus bar that is provided in the direction of lamination. The plurality of film-sheathed batteries described in Patent Document 1 are each mounted and stacked in a frame body composed of, for example, aluminum.

Alternatively, Patent Document 2 discloses a configuration in which the positions of a plurality of positive electrode terminals and negative electrode terminals that are the objects of joining of each film-sheathed battery are shifted such that the positions of the positive electrode terminals and negative electrode terminals do not overlap when viewed from the direction of lamination.

### RELATED ART DOCUMENTS

### Patent Documents

Patent Document 1: JP 2005-222699 A

Patent Document 2: JP 2009-277673 A

### SUMMARY

### Problem to be Solved by the Invention

In the battery pack disclosed in Patent Document 1 described above, the external terminals of the plurality of film-sheathed batteries can be relatively easily connected together by using a bus bar. In addition, the battery pack disclosed in Patent Document 1 is of a configuration that holds the peripheral side surfaces of each film-sheathed battery by a frame body and therefore improves the resistance of each film-sheathed battery against shocks from the outside.

However, the battery pack disclosed in Patent Document 1 increases in weight due to the provision of the frame body and bus bar, and the advantage of lighter weight obtained by using a film-sheathed battery is therefore lost.

In contrast, the technology disclosed in Patent Document 2 does not use a frame body or bus bar and therefore is not subject to an increase in weight of the battery pack.

In the technology disclosed in Patent Document 2, however, an increase of the number of stacked film-sheathed batteries necessitates a decrease of the widths of the positive electrode terminals and negative electrode terminals, and this decrease in width interferes with the flow of large current in the positive electrode terminals and negative electrode terminals. On the other hand, maintaining the widths of the positive electrode terminals and negative electrode terminals at certain degree places a limitation on the number of film-sheathed batteries that can be stacked and therefore prevents the output of high voltage from the battery pack. As a result, the technology disclosed in Patent Document 2 is difficult to apply to high-power battery packs. In addition, the technology disclosed in Patent Document 2 necessitates the preparation of a plurality of types of film-sheathed batteries having positive electrode terminals and negative electrode terminal at different positions, and this requirement complicates the manufacturing steps of the battery pack and raises manufacturing costs.

The present invention was realized to provide a solution to the problems inherent to the above-described background art and has as its object the provision of a battery pack and a manufacturing method of a battery pack that can be applied to the manufacture of high-power battery packs and that can limit increase of manufacturing costs.

### Means for Solving the Problem

An exemplary aspect of a manufacturing method of a battery pack of the present invention for achieving the above-described object is a manufacturing method of a battery pack that is provided with a plurality of unit cells that are stacked, the manufacturing method including a step of:

when the unit cell that is arranged on one outermost layer is referred to as the first unit cell, and, of the plurality of unit cells that are stacked in order from the first unit cell, the unit cell that is arranged on the other outermost layer opposite to the first outermost layer is referred to as the N^{th}, where N is a positive number equal to or greater than 2, unit cell,

arranging an anvil outside the battery pack at an external terminal that is provided in the N^{th} unit cell, arranging a horizontal-vibration horn outside the battery-pack at an external terminal provided in the (N−1)^{th} unit cell, or between an external terminal provided in the (N−1)^{th} unit cell and an external terminal provided in the (N−2)^{th} unit cell; and

then using the anvil and the horn to ultrasonically join the external terminal of the N^{th} unit cell and the external terminal of the (N−1)^{th} unit cell.

An exemplary aspect of a battery pack of the present invention has a plurality of unit cells that are each provided with two external terminals that are a positive electrode terminal and a negative electrode terminal and are stacked and connected in series,

wherein of the external terminals that are provided in the unit cell that is arranged on the outermost layer, the outermost terminal that is the external terminal that is not joined with the external terminal of the adjacent unit cell in the direction of stacking is of a configuration bent in a direction away from the adjacent unit cells.

### Effect of the Invention

The present invention can be applied to the manufacture of a high-power battery pack and can reduce increase of manufacturing costs of the battery pack.

### BRIEF DESCRIPTION OF THE DRAWINGS

FIG. 1 is a perspective view showing an example of the configuration of a battery pack of the first exemplary embodiment.

FIG. 2A is a plan view giving a schematic representation of an example of the processing procedure of a manufacturing method of the battery pack shown in FIG. 1.

FIG. 2B is a sectional side view giving a schematic representation of an example of the processing procedure of a manufacturing method of the battery pack shown in FIG. 1.

FIG. 2C is a sectional side view giving a schematic representation of an example of the processing procedure of a manufacturing method of the battery pack shown in FIG. 1.

FIG. 3 is a sectional side view giving a schematic representation of an example of a manufacturing method of the battery pack of the second exemplary embodiment.

FIG. 4 is a perspective view showing an example of the configuration of the battery pack of the third exemplary embodiment.

### EXEMPLARY EMBODIMENT

The present invention is next described with reference to the accompanying drawings.

### FIRST EXEMPLARY EMBODIMENT

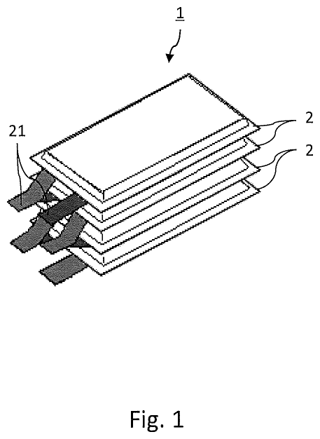

FIG. 1 is a perspective view showing an example of the configuration of the battery pack of the first exemplary embodiment.

As shown in FIG. 1, battery pack 1 of the first exemplary embodiment is of a configuration provided with a plurality (four in FIG. 1) of unit cells 2 in which the plurality of unit cells 2 are stacked.

Unit cells 2 provided in battery pack 1 shown in FIG. 1 are of a configuration in which two external terminals 21 (positive electrode terminal and negative electrode terminal) are led out from one short side of the battery main body. The plurality of unit cells 2 are stacked such that the positions of each of the positive electrode terminals and negative electrode terminals alternately switch.

In each of the stacked unit cells 2, one external terminal 21 (positive electrode terminal or negative electrode terminal) is joined with the other external terminal 21 (negative electrode terminal or positive electrode terminal) of one adjacent unit cell 2 in the direction of stacking. In addition, the other external terminal 21 (negative electrode terminal or positive electrode terminal) of each stacked unit cell 2 is joined with the other external terminal 21 (positive electrode terminal or negative electrode terminal) of the other unit cell 2 that is adjacent in the direction of stacking. In this way, the plurality of stacked unit cells 2 are electrically connected in series.

The plurality of unit cells 2 that have been stacked and connected in series are secured at sites other than external terminals 21 such that the mutual positioning does not shift. The positions of the plurality of unit cells 2 should be secured by housing in, for example, a case (not shown). In addition, the positions of the plurality of unit cells 2 may be secured by using double-sided tape to adhere together unit cells 2 that are adjacent in the direction of stacking. Alternatively, the positions of the plurality of unit cells 2 may be secured by using belt-like fixing bands to bind the unit cells 2 in the direction parallel to their short sides. The positions of the plurality of unit cells 2 may be secured by combining the various methods described above.

There are external terminals 21 (hereinbelow referred to as outermost terminals) that are not joined to external terminals 21 of adjacent unit cells 2 on unit cells 2 of the outermost layers (lowermost layer and uppermost layer) of the plurality of unit cells 2 that have been stacked and connected in series. These outermost terminals are joined to extension terminals that, as seen from the direction of stacking, project to the outer peripheral side of external terminals 21 other than the outermost terminals. The extension terminals or cables that are connected to the extension terminals are led out to the outside from battery pack 1. The extension terminals or the cables that are led out to the outside from battery pack 1 are used for charging/discharging battery pack 1.

Unit cells 2 are not limited to a configuration in which two external terminals 21 (positive electrode terminal and negative electrode terminal) are led out from one of the short sides of battery main body as shown in FIG. 1. Unit cells 2 may be of a configuration in which, for example, positive electrode terminals are led out from one of the short sides of the battery main body and negative electrode terminals are led out from the other short side.

Film-sheathed batteries are used in each unit cell 2 that makes up battery pack 1. The film-sheathed batteries are of a configuration in which, as described above, positive electrodes and negative electrodes (not shown in the figures) in sheet form having separators (not shown) interposed are laminated or wound and then enclosed together with electrolyte inside a sheathing film that is the sheathing body. The outer periphery of a film-sheathed battery is sealed by heat-sealing two sheathing films together.

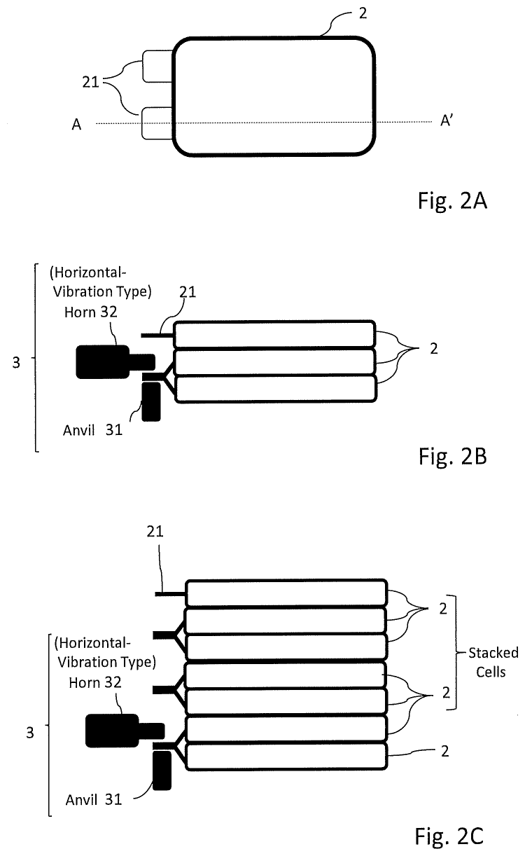

FIGS. 2A-C give schematic representations of an example of the processing procedure of the manufacturing method of the battery pack shown in FIG. 1. FIG. 2A is a plan view as viewed from the direction of stacking of the battery pack shown in FIG. 1, and FIGS. 2B and C show sectional side views as seen from line A-A′ of FIG. 2A. In addition, FIGS. 2B and C show the cases in which the number of stacked layers of unit cells 2 is increased in the manufacturing steps of battery pack 1, FIG. 2B showing a state in which three unit cells 2 are stacked and FIG. 2C showing a state in which seven unit cells 2 are stacked.

As shown in FIGS. 2B and C, in the present exemplary embodiment, external terminals 21 of two unit cells 2 that are adjacent in the direction of stacking are joined together using a known ultrasonic joining machine 3. Ultrasonic joining machine 3 has anvil 31 on which are mounted a pair of external terminals 21 that are the object of joining and horn 32 that is arranged to face anvil 31 with the pair of external terminals 21 interposed. Ultrasonic joining machine 3 uses horn 32 to apply ultrasonic vibrations while pressing the pair of external terminals 21 in the direction of anvil 31 and thus join the pair of external terminals 21 together.

As previously described, external terminals 21 of other stacked unit cells 2 are positioned above or below the pair of external terminals (positive electrode terminal and negative electrode terminal) 21 that are the objects of joining, and as a result, the problem arises that the working space required for joining is confined.

In response, in the present exemplary embodiment, ultrasonic joining machine 3 that is provided with horizontal-vibration horn 32 is used to enable joining external terminals together in the confined working space. Horizontal-vibration horn 32 uses side-surface vibrations to carry out joining, whereby even relatively thinly formed external terminals 21 can be joined together. Accordingly, even when external terminals 21 of another unit cell 2 are positioned above the pair of external terminals 21 that are the objects of joining as shown in FIG. 2B, external terminals 21 of this other unit cell 2 need not be displaced away from the working space required for joining.

Further, in the present exemplary embodiment, as shown in FIGS. 2B and C, when external terminals 21 of adjacent unit cells 2 have been joined together, unit cell 2 that is to be stacked next is arranged below the plurality of stacked unit cells 2. External terminals 21 of unit cell 2 that is to be stacked next are then joined to external terminals 21 of the lowermost-layer unit cell 2 of the plurality of unit cells 2 that have been stacked (hereinbelow referred to as “stacked cells”). At this time, anvil 31 is set below external terminals 21 of unit cell 2 that is to be stacked next, and horn 32 is arranged between external terminals 21 of lowermost unit cell 2 of the stacked cells and external terminals 21 of second unit cell 2 from the lowermost layer.

FIGS. 2B and C show an example in which unit cell 2 that is to be stacked next is arranged below the stacked cells, but the present invention is not limited to this arrangement example. For example, unit cell 2 that is to be stacked next may be arranged above the stacked cells, and external terminals 21 of unit cell 2 that is to be stacked next may be joined with external terminals 21 of unit cell 2 of the uppermost layer of the stacked cells. In this case, anvil 31 should be set above external terminals 21 of the unit cell 2 that is to be stacked next and horn 32 should be arranged between external terminals 21 of the uppermost-layer unit cell 2 of the stacked cells and external terminals 21 of the second unit cell 2 from the uppermost layer.

In other words, in the present exemplary embodiment, when unit cell 2 that is arranged on one outermost layer is taken as the first unit cell, and of the plurality of unit cells 2 that are stacked in order from the first unit cell, unit cell 2 that is arranged on the other outermost layer that is opposite the first outermost layer is taken as the N^{th} (where N is a positive number equal to or greater than 2) unit cell, anvil 31 is arranged outside battery pack 1 at external terminal 21 that is provided in the N^{th} unit cell and horizontal-vibration horn 32 is arranged outside battery pack 1 at external terminal 21 that is provided in the (N−1)^{th} unit cell or between external terminal 21 that is provided in the (N−1)^{th} unit cell and external terminal 21 that is provided in the (N−2)^{th} unit cell, and external terminal 21 of the N^{th} unit cell and external terminal 21 of the (N−1)^{th} unit cell are then joined by ultrasonic joining.

When external terminal 21 of the N^{th} unit cell is joined to external terminal 21 of the (N−1)^{th} unit cell, the first unit cell to the (N−1)^{th} unit cell are assumed to be stacked and connected in series.

Joining together external terminals 21 while a plurality of unit cells 2 are successively stacked in one direction in this way ensures that there will be sufficient space for arranging anvil 31 outside battery pack 1 of unit cell 2 of the outermost layer.

Further, an example was shown in the explanation above in which anvil 31 is arranged outside battery pack 1 at external terminal 21 of the N^{th} unit cell, and horizontal-vibration horn 32 is arranged outside battery pack 1 at external terminal 21 of the (N−1)^{th} unit cell or between external terminal 21 of the (N−1)^{th} unit cell and external terminal 21 of the (N−2)^{th} unit cell. However, when a thinly-formed anvil 31 can be used, the positional relation of this anvil 31 and horn 32 may be reversed.

In addition, when a pair of external terminals 21 that are the objects of joining are to be joined together, the joining site in external terminals 21 need not be one site. The joining site in external terminals 21 may also be a plurality of locations if the joining operation is possible.

According to the first exemplary embodiment, horizontal-vibration horn 32 is used to join together external terminals 21 of adjacent unit cells 2, and external terminals 21 can thus be joined together even in a relatively confined work space. As a result, a plurality of types of film-sheathed batteries in which the positions of positive electrode terminals and negative electrode terminals differ need not be prepared, as in the battery pack disclosed in Patent Document 2.

Because external terminals 21 are joined together while successively stacking a plurality of unit cells 2 in one direction, sufficient space can be insured for arranging anvil 31 (or horn 32) outside battery pack 1 at unit cells 2 that are arranged in the outermost layer.

Accordingly, a battery pack can be easily manufactured without complicated manufacturing steps. As a result, an increase of the manufacturing cost of the battery pack is prevented.

Still further, according to the first exemplary embodiment, there is no constraint upon the width of external terminals 21 (positive electrode terminals and negative electrode terminals) according to the number of stacked layers of unit cells 2, as in the battery pack shown in Patent Document 2. As a result, the manufacturing method of a battery pack of the first exemplary embodiment can be applied to the manufacture of a high-power battery pack.

### SECOND EXEMPLARY EMBODIMENT

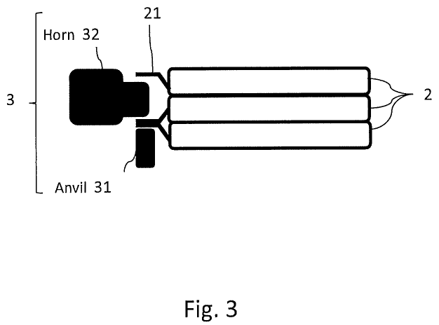

FIG. 3 is a sectional side view giving a schematic representation of an example of the manufacturing method of a battery pack of the second exemplary embodiment. FIG. 3 shows a sectional side view as seen from line A-A′ of FIG. 2A, similar to FIGS. 2B and C.

As shown in FIGS. 2B and C, in the battery pack 1 of the first exemplary embodiment, external terminals 21 of each unit cell 2 are bent toward adjacent unit cell 2 that is the joining partner, whereby the tips of the external terminals 21 are positioned in the vicinity of the border with this adjacent unit cell 2.

However, as shown in FIG. 2B, of two external terminals 21 that are provided in outermost-layer unit cells 2, the outermost terminals that are not joined to external terminals 21 of adjacent unit cells 2 are not bent toward the adjacent unit cells 2.

Accordingly, the space between outermost terminals that are not joined with external terminals 21 of the adjacent unit cells 2 and external terminals 21 of unit cells 2 that are positioned second from the outermost layers is smaller than the space between other adjacent external terminals 21 after joining. As a result, the thickness of horn 32 must be selected while taking into consideration the distance between the outermost terminals and external terminals 21 of unit cells 2 that are positioned second from the outermost layer.

In the second exemplary embodiment, as shown in FIG. 3, of the two external terminals 21 provided in unit cell 2 of the outermost layer (the uppermost layer in FIG. 3) of battery pack 1, external terminal 21 that is the outermost terminal is bent in a direction away from adjacent unit cell 2. As a result, in the second exemplary embodiment, the distance between the outermost terminal and external terminals 21 of unit cell 2 that is positioned second from outermost layer is greater than in the first exemplary embodiment. Accordingly, in the manufacturing method of the battery pack of the second exemplary embodiment, a large horn 32 can be used that is thicker than in the first exemplary embodiment.

According to the second exemplary embodiment, not only can the same effects be obtained as in the first exemplary embodiment, but the degree of freedom in selecting horn 32 that is used in ultrasonic joining is improved over the first exemplary embodiment.

### THIRD EXEMPLARY EMBODIMENT

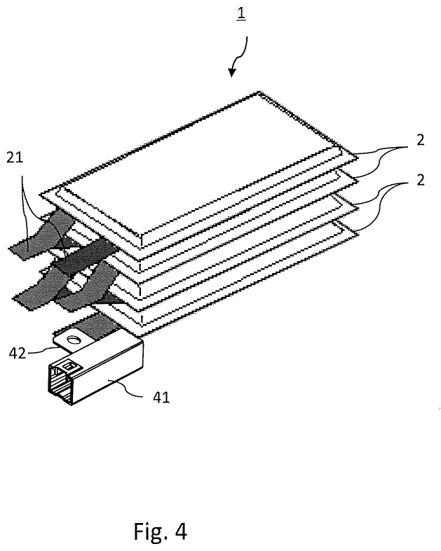

FIG. 4 is a perspective view showing an example of the configuration of the battery pack of the third exemplary embodiment.

As described above, in the first exemplary embodiment, extension terminals are connected to the above-described outermost terminals, and these extension terminals or cables that are connected to these extension terminals are led out to the outside and used in charging/discharging of battery pack 1.

Because battery packs in recent years are required to supply as the discharge current a high output current on the order of 100A, the number of connection points is preferably decreased to reduce the contact resistance between the outermost terminals and the load to which the discharge current is supplied from battery pack 1.

As shown in FIG. 4, in the third exemplary embodiment, bus-bar-connected connector 41 is connected to, of the two external terminals 21 that are provided in outermost-layer unit cell 2 of battery pack 1, external terminal 21 (outermost terminal) that is not joined with external terminal 21 of the adjacent unit cell 2. Bus bar unit 42 that is provided in bus-bar-connected connector (receptacle) 41 may be directly joined to the outermost terminal using ultrasonic joining machine 3.

The outermost terminal to which bus bar unit 42 is connected may be a straight form (refer to FIGS. 2B and C) as shown in the first exemplary embodiment or may be bent as shown in the second exemplary embodiment (refer to FIG. 3).

A plug that corresponds to the receptacle may be inserted into bus-bar-connected connector (receptacle) 41, and a cable that is connected to the plug may be led to the outside of battery pack 1. The DW4-series made by Japan Aviation Electronics Industry, Ltd. can be used as bus-bar-connected connector 41.

FIG. 4 shows an example in which bus-bar-connected connector 41 is connected to the outermost terminal provided in, of the plurality of unit cells 2 that are provided in battery pack 1 (three in FIG. 4), the lowermost-layer unit cell 2. Bus-bar-connected connector 41 may connect to the outermost terminal provided in uppermost-layer unit cell 2 of battery pack 1 or may connect to each of the outer terminals provided in the lowermost-layer and uppermost-layer unit cells 2.

The third exemplary embodiment not only obtains the same effects as the first and second exemplary embodiments but can also be applied to battery pack 1 for which a higher output current is required than for the first and second exemplary embodiments.

Although the invention of the present application has been described above with reference to exemplary embodiments, the invention of the present application is not limited to the above-described exemplary embodiments. The configuration and details of the invention of the present application is open to various modifications within the scope of the invention of the present application that will be clear to one of ordinary skill in the art.

1. A manufacturing method of a battery pack that is provided with a plurality of unit cells that are stacked, comprising the steps of:
when a unit cell that is arranged on one outermost layer is referred to as the first unit cell, and, of the plurality of unit cells that are stacked in order from said first unit cell, the unit cell that is arranged on the other outermost layer opposite to said first outermost layer is referred to as the N^{th}, where N is a positive number equal to or greater than 2, unit cell,
arranging an anvil outside said battery pack at an external terminal that is provided in said N^{th} unit cell, arranging a horizontal-vibration horn outside said battery pack at an external terminal that is provided in the (N−1)^{th} unit cell or between the external terminal provided in said (N−1)^{th} unit cell and the external terminal provided in the (N−2)^{th} unit cell; and
then using said anvil and said horn to ultrasonically join the external terminal of said N^{th} unit cell and the external terminal of said (N−1)^{th} unit cell.

2. The manufacturing method of a battery pack according to claim 1, wherein, when joining an external terminal provided in said N^{th} unit cell and an external terminal provided in said (N−1)^{th} unit cell, said first unit cell to said (N−1)^{th} unit cell are stacked.

3. The manufacturing method of a battery pack according to claim 1, wherein said first unit cell to said N^{th} unit cell are connected in series.

4. The manufacturing method of a battery pack according to claim 1, wherein an external terminal of said N^{th} unit cell and an external terminal of said (N−1)^{th} unit cell are ultrasonically joined at a plurality of sites.

5. The manufacturing method of a battery pack according to claim 1, wherein said plurality of unit cells are secured together at sites other than said external terminals.

6. The manufacturing method of a battery pack according to claim 1, wherein:
said first unit cell and said N^{th} unit cell are provided with outermost terminals that are external terminals for which said external terminals are not joined with unit cells that are adjacent in the direction of stacking; and
said outermost terminals are joined with extension terminals that protrude further to the outer periphery as seen from the direction of stacking than said external terminals other than said outermost terminals.
